(19) United States
(12) Patent Application Publication
(10) Pub. No.: US 2025/0091826 A1
(43) Pub. Date: Mar. 20, 2025

(54) RAMP COUPLING ADAPTER AND RAMP FOR A PORTABLE DOCK LIFT

(71) Applicant: Ballymore Company, Inc., Coatsville, PA (US)

(72) Inventor: Christopher M. Orlando, Media, PA (US)

(21) Appl. No.: 18/888,827

(22) Filed: Sep. 18, 2024

Related U.S. Application Data
(60) Provisional application No. 63/583,407, filed on Sep. 18, 2023.

(51) Int. Cl. B65G 69/24; B65G 69/30

(52) U.S. Cl. CPC B65G 69/24; B65G 69/30

(57) ABSTRACT

A ramp and coupling adapter for a portable dock lift includes a ramp and a separate coupling adapter that interfaces between the ramp and the dock lift into a use position.

### CROSS REFERENCE TO RELATED APPLICATIONS

This application also claims the benefit of U.S. Provisional Application No. 63/583,407, filed Sep. 18, 2023. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### Field

The Invention relates to a ramp and a coupling adapter for a portable dock lift. Existing dock lifts use permanently installed ramps anchored into the ground. To make this dock lift portable, the lift's structure has fork lift pockets. The fork lift pockets accept the adapter, which is retained with pins. The ramp structure is lowered into a channel/cradle and centered with angled features. A tailgate on the lift's deck folds down and lines up in the top of the ramp to make a smooth transition for loading. This allows both the dock and ramp to be moved by forklift and temporarily setup on level ground in less than ten minutes without tools.

Accordingly, there is a need for a new and improved ramp and coupling adapter for a portable dock lift.

### SUMMARY

Disclosed herein is a ramp and coupling adapter for a portable dock lift includes a ramp and a separate coupling adapter that interfaces between the ramp and the dock lift into a use position.

In one form of the invention, the ramp and coupling adapter includes a transverse channel and a pair of extending tubular member extending therefrom for interfacing with complementary structure on the portable dock lift. A locking pin can be included that locks the coupling adapter to the portable lift dock.

The ramp may have a complementary cut out portion for accepting the transverse channel of the coupling adapter to link the coupling adapter to the ramp. And may include a transversely extending channels and/or tubular members for accepting the tines of a fork lift.

### BRIEF DESCRIPTION OF THE DRAWINGS

The embodiments will be described in detail with reference to the following drawings in which like reference numerals refer to like elements wherein:

FIG. 1 shows a perspective view of a ramp and a complementary ramp coupling adapter for a portable dock lift in accordance with the present invention.

FIG. 2 shows an expanded perspective view of the ramp and coupling adapter for a portable lift dock of the present invention of FIG. 1.

FIG. 3 shows a top perspective view of a ramp in accordance with the present invention of FIG. 1.

FIG. 4 shows a bottom view of a ramp in accordance with the present invention of FIG. 1.

FIG. 5 shows a bottom perspective view of a ramp in accordance with the present invention of FIG. 1.

FIG. 6 shows a top perspective view of the perspective view of ramp coupling adapter of the present invention of FIG. 1.

FIG. 7 shows a side view of the perspective view of ramp coupling adapter of the present invention of FIG. 1.

### DETAILED DESCRIPTION

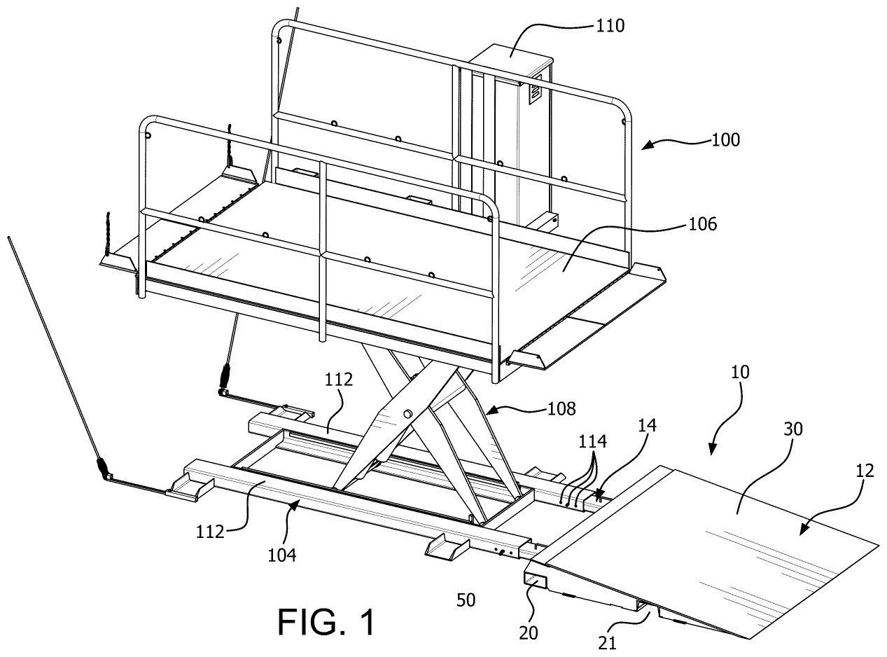

In FIGS. 1-7, there is shown a presently preferred implementation of a ramp and coupling adapter 10 for a portable dock lift 100 in accordance with the present invention. The ramp and coupling adapter 10 include a ramp 12 and a complementary adapter 14 design that is portable and temporary and together designed to serve as a ramp for the portable dock lift 100.

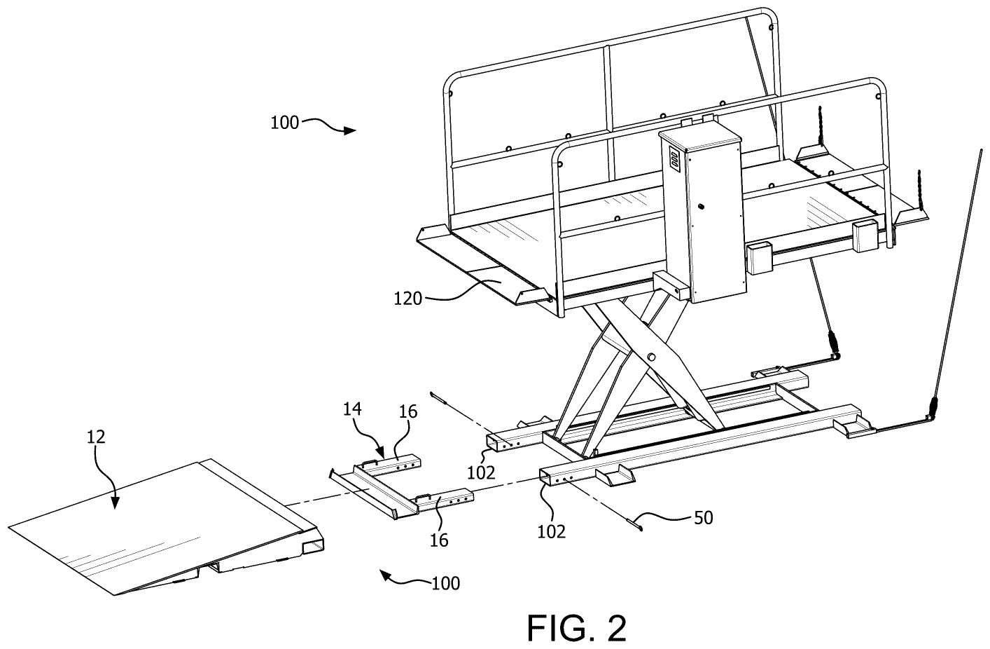

As best seen in FIGS. 1-2, the Dock Lift 100 comprises a base 104 and a raisable and lowerable deck 106 connected to the base 104 by scissors 108. The dock lift 100 preferably includes a drive unit 110, preferably DC battery powered and preferably does not require external power for operation. Other alternate lift docks are contemplated, however, and fall within the scope of the present invention.

The base 104 of dock lift 100 also includes laterally extending tubular members 112 having fork pockets 102 which accept extending portions 16 of the coupling adapter 14, as described in greater detail below. The coupling adapter 14 installs into dock lift fork pocket 102 and is retained with pins 30 which are inserted into one of the receiving holes 118 located on the side walls of the tubular members 112

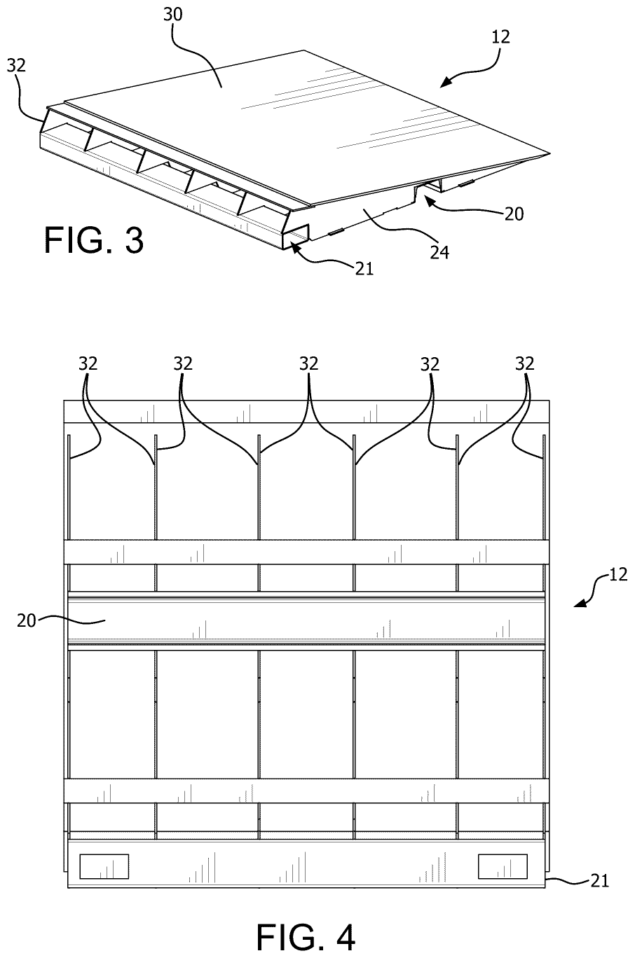

Turning now to FIGS. 3-5, the ramp 12 of the ramp and coupling adapter 10 will be described. The ramp 12 includes a top inclined planar surface 30 forming a ramp surface. A series of spaced strengthening ribs 32 run laterally with the top planar surface 30 forming the underside of the ramp 12. Transversely extending fork pocket 20 and tubular member 21 are formed in the ramp 12 for accepting the tines of a forklift for lifting/moving the ramp 12 with a forklift (not shown), such as to position the ramp 12 on the adapter 14, for example.

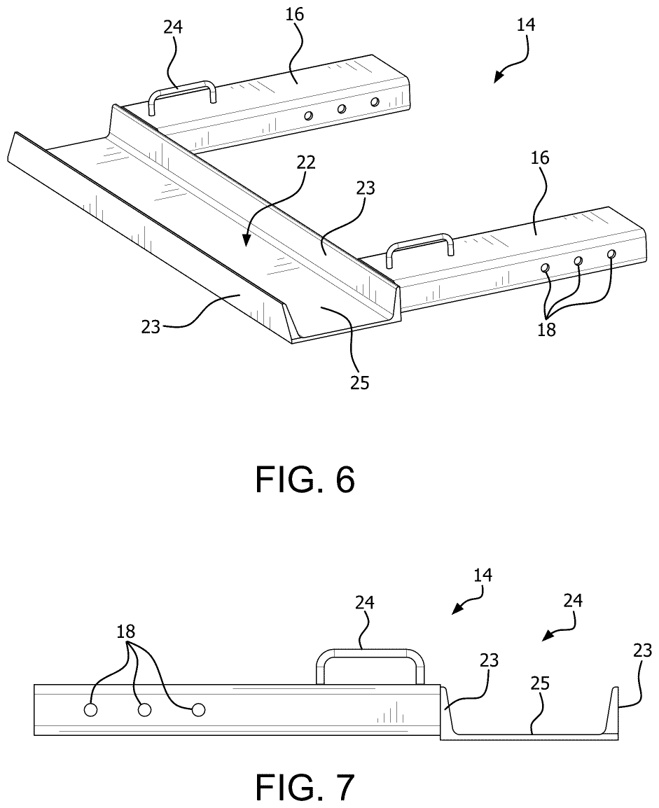

Turning now to FIGS. 6 and 7, the adapter 14 comprises a transversely extending C-channel member 22 having upwardly extending walls 23 that extend from a base 25. A pair of spaced tubular members 16 extend laterally from the C channel member 22. The tubular members are sized, shaped, and spaced to fit within fork pocket 102 the tubular members 112 of the dock lift 100. A series of spaced holes 18 formed in each tubular member 16 are sized and spaced to align with the holes 118 formed in each tubular member 112 to receive a pin 50, or other locking device, to lock the adapter 14 to the dock lift 100.

A pair of handles 24 are formed on the upper surface of the tubular members 16 to aid in lifting, carrying, and positioning the adapter 14.

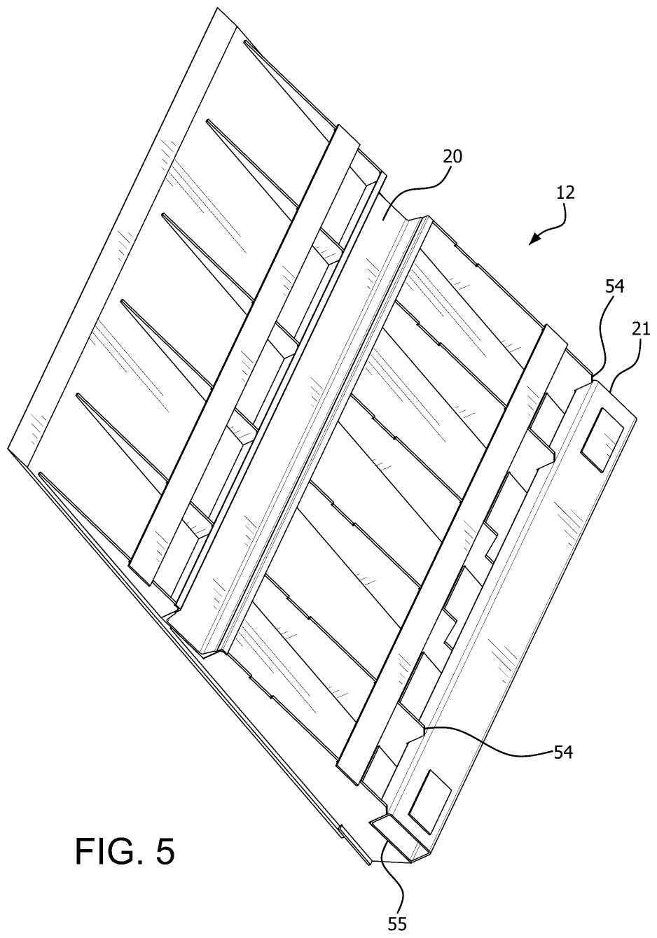

Referring back to FIGS. 1-7, The ramp 12 includes a cut-out portion 55 which is shaped to accept the complementary channel/tubular member 21 of the adapter 14 to locate the ramp 12 lengthwise onto the adapter 14. Inclined portions 54 formed on laterally disposed ribs 32 formed on the ramp 12 locate the ramp 12 side to side on the ramp adapter 14 as it is lowered in place thereon, as best seen in FIGS. 1 and 5.

The ramp 12 and adapter 14 are man or forklift portable. Setup requires no special tools. Additionally, setup does not require modifications to the parking ground surface substrate on which the ramp is to be deployed.

In one form of the invention, the ramp 12 can be stored/transported on the deck of Dock Lift 100. The ramp adapter 14 preferably includes a storage location on one or more sides of Dock Lift 100.

Existing dock lifts use permanently installed ramps anchored into the ground. To make this dock lift portable, the lift's structure has fork lift pockets, members 112. The fork lift pockets 112 also accept the adapter 14, which is retained with pins 50. The ramp structure 10 is lowered into the channel/cradle 24 and centered with angled features 54. A tailgate 120 on the lift's deck folds down and lines up in the top 30 of the ramp 12 to make a smooth transition for loading. This allows both the dock left 100 and ramp 12 to be moved by forklift and temporarily setup on level ground in less than ten minutes without tools.

This installation is temporary and setup is fast. The dock lift 100 can be stored indoors until it is needed. This can save parking lot space, reduce tampering, reduce environmental wear and tear. It can be setup without modification/damage to parking lot substrate for leased property. It does not require any special tools or a power hookup, since the lift is battery powered.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A ramp and coupling adapter for a portable dock lift comprising:
a ramp and
a separate coupling adapter that interfaces between the ramp and the dock lift into a use position.

2. A ramp and coupling adapter according to claim 1, wherein the adapter comprises a transverse channel and a pair of extending tubular member extending therefrom for interfacing with complementary structure on the portable dock lift.

3. A ramp and coupling adapter according to claim 2 further comprising a locking pin for locking the coupling adapter to the portable lift dock.

4. A ramp and coupling adapter according to claim 3 wherein the ramp has a complementary cut out portion for accepting the transverse channel of the coupling adapter to link the coupling adapter to the ramp.

5. A ramp and coupling adapter according to claim 4 wherein the ramp includes transversely extending channels and/or tubular members for accepting the tines of a fork lift.

6. A portable dock comprising:
a raisable deck;
a separate ramp; and
a separate coupling adapter that interfaces between the ramp and the dock lift into a use position.

7. A portable dock according to claim 6 wherein the adapter comprises a transverse channel and a pair of extending tubular member extending therefrom for interfacing with complementary structure on the portable dock lift.

8. A portable dock according to claim 7 further comprising a locking pin for locking the coupling adapter to the portable lift dock.

9. A portable dock according to claim 8 wherein the ramp has a complementary cut out portion for accepting the transverse channel of the coupling adapter to link the coupling adapter to the ramp.

10. A portable dock according to claim 9 wherein the ramp includes transversely extending channels and/or tubular members for accepting the tines of a fork lift.
